(19) United States
(12) Patent Application Publication
(10) Pub. No.: US 2009/0245823 A1
(43) Pub. Date: Oct. 1, 2009

(54) DEVELOPING DEVICE AND IMAGE FORMING APPARATUS

(75) Inventors: Koji MIGITA, Matsumoto-shi (JP); Katsumi OKAMOTO, Azumino-shi (JP); Makoto SATO, Matsumoto-shi (JP); Takeshi AOKI, Matsumoto-shi (JP); Masashi NAKATSU, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/407,092

(22) Filed: Mar. 19, 2009

(30) Foreign Application Priority Data
Mar. 31, 2008 (JP) 2008-089050

(51) Int. Cl. G03G 21/20; G03G 15/08

(52) U.S. Cl. 399/44; 399/254; 399/53

(57) ABSTRACT

A developing device includes a housing that forms a development chamber therein and a developer containing portion that forms a developer containing chamber therein and contains a one-component developer. A first transport path supplies a developer from the developer containing chamber to an upper side of the development chamber. A second transport path collects a developer from a lower side of the development chamber to the developer containing chamber. A developer carrier is disposed in the development chamber and carries a developer thereon. A developer supply member is disposed in the development chamber and supplies a developer to the developer carrier. A regulating member is in contact with the developer carrier and regulates a developer on a surface of the developer carrier. Stirring of the developer in the development chamber is performed by driving the first transport path and the second transport path to transport the developer.

### BACKGROUND

1. Technical Field

The present invention relates to a developing device that develops an electrostatic latent image on a latent image carrier with a one-component developer and an image forming apparatus including the same.

2. Related Art

An electrophotographic recording type image forming apparatus that forms an electrostatic latent image based on image data on a surface of a latent image carrier by exposure is known. In the image forming apparatus, an image is formed by developing the electrostatic latent image with a developer by a developing device and transferring the developed image on the surface of the latent image carrier onto a recording medium, such as recording paper.

Various image forming apparatuses are known as such an image forming apparatus. For example, as shown in FIG. 2 of JP-A-11-102106 or FIG. 1 of JP-A-2007-178698, a vertical type image forming apparatus, which develops an electrostatic latent image of a latent image carrier by arraying developing devices corresponding to respective colors in a vertical direction, or a tandem type image forming apparatus, which develops an electrostatic latent image of a latent image carrier by arraying developing devices in a horizontal direction, is known.

As developers used in such image forming apparatuses, a two-component developer containing carrier and toner and a one-component developer (magnetic toner, non-magnetic toner) containing only toner without a carrier are known. In the case of the two-component developer, the concentration of toner decreases as only the toner is consumed. Accordingly, the mixing ratio of carrier and toner needs to be maintained constant. In this case, however, the developing device becomes large, which is disadvantageous.

On the other hand, the one-component developer is advantageous in that the device is small, and the one-component developer may be easily used under the adverse environment of low temperature and low humidity or high temperature and high humidity. For this reason, the one-component developer is mainly used for development.

Particularly in the non-magnetic one-component developing method, toner (developer) does not have a magnetic force. Accordingly, the toner is supplied onto a developer carrier in a state where a supply roller or the like is pressed against the developer carrier so that the toner has the electrostatic force, the toner is made thin by a regulating member, and development is performed. In this case, since a colored magnetic substance is not contained, there is an advantage that it is possible to cope with colorization. Moreover, since a magnet is not used for the developer carrier, the apparatus may be made light with low cost. For this reason, small full-color printers and the like have been put to practical use in recent years.

However, there are many issues to be solved in the one-component developing method. That is, in the two-component developing method, toner and carrier are sufficiently stirred and mixed in a development chamber by the carrier as a toner charging and transporting unit and are then supplied to the developer carrier so that the toner and carrier are used for development. Accordingly, charging and transporting can be stably maintained even if the toner is used for a relatively long period of time. In addition, the two-component developing method is easily adopted also in a high-speed developing device.

In contrast, in the one-component developing method, there is no stable charging and transporting unit such as a carrier. Accordingly, charging failure or transport failure caused by long use or an increase in speed easily occurs. Particularly in the one-component developing method, the development is performed by supplying the toner onto a developer carrier and then making the toner thin using the regulating member. However, the contact and frictional charging time of the toner and the developer carrier or a frictional charging unit, such as the regulating member, is short. Accordingly, in the one-component developing method, the amount of low-charged and opposite-charged toner tends to increase compared with that in the two-component developing method using the carrier.

Examples of the cause of deterioration of toner (developer) include a drop in fluidity of the toner, which occurs when a hydrophobic silica externally added to the toner by the mechanical stress applied to the toner is gradually buried in the toner or separated from the toner, a drop in fluidity that is caused by an increase of toner particles with small diameters due to crushing of the toner, and generation of an agglomerate when toner the fluidity of which has lowered gathers. These are causes of deterioration of an output image.

In the case of toner particles with small diameters, the charged amount thereof is easily increased excessively and the image force onto a latent image carrier works strongly. Accordingly, adhesion (fogging and regulation passing failure) of the toner particles with small diameters onto a non-image portion is observed. In addition, the toner particles with small diameters are easily scattered. Accordingly, the toner particles with small diameters cause internal contamination of the image forming apparatus since the toner particles with small diameters are scattered through an opening of the developing device.

When the fluidity of toner drops, the frictional charging of the toner within the developing device becomes insufficient. As a result, toner with an opposite polarity to a desired charging polarity is generated. The toner with the opposite polarity is also observed as fogging of an image. In addition, since toner the fluidity of which has lowered or the agglomerate cannot smoothly pass a contact portion between the developing roller and the regulating member, charging becomes insufficient. This causes fogging of an image. In addition, the agglomerate is fused (so-called filming) on a surface of the developing roller or regulating member by the mechanical force and frictional heat in the contact portion between the developing roller and the regulating member. When the agglomerate is extremely large, the agglomerate clogs the contact portion. As a result, in the contact portion where filming and the like have occurred, a layer of toner is not formed on the developer roller and an image corresponding thereto is observed as white stripes (missing of an image).

Moreover, when toner is newly supplied as toner in the development chamber is consumed, the deteriorated toner described above and the new toner become mixed unevenly if the new toner is supplied in a condition where the deteriorated toner remains in the development chamber. Mixing of the uneven toner is the cause of deterioration of an output image, such as regulation passing failure and fogging. Moreover, a decrease in the charging amount of deteriorated toner is the cause of deterioration of an output image, such as a decrease in the print concentration or development record.

JP-A-2004-029198 discloses an image forming apparatus which includes a photoconductor, on which a latent image can be formed, and a movable body having a plurality of attachment portions, to which or from which a developing device having a developer containing portion for containing a developer used to develop the latent image on the photoconductor can be attached or detached, and which is able to improve the quality of an output image by stirring the developer in the developer containing portion so that agglomeration of the developer in the developing device mounted in the image forming apparatus is removed by moving the movable body while any of the plurality of developing devices mounted in the plurality of attachment portions does not develop the latent image on the photoconductor.

If the configuration disclosed in JP-A-2004-029198 in which the developing device of the image forming apparatus is moved can be applied to any kind of image forming apparatus, uneven mixing of deteriorated toner and new toner can be prevented. However, for example, in the image forming apparatus in which developing devices are arrayed in the vertical direction or the tandem type image forming apparatus in which developing devices are arrayed in the horizontal direction disclosed in JP-A-11-102106 or JP-A-2007-178698, it is so difficult to move the developing devices in order to stir the developer, in terms of the configuration. Particularly in the configuration where a development chamber and a developer containing chamber are separated from each other and a developer is supplied from the developer containing chamber as a developer in the development chamber decreases, it is difficult to stir the developer as disclosed in JP-A-2004-029198.

### SUMMARY

In order to solve the above-described problems, according to an aspect of the invention, a developing device includes: a housing that forms a development chamber therein; a developer containing portion that forms a developer containing chamber therein and contains a one-component developer; a first transport path used to supply a developer from the developer containing chamber to an upper side of the development chamber; a second transport path used to collect a developer from a lower side of the development chamber to the developer containing chamber; a developer carrier that is disposed in the development chamber and carries a developer thereon; a developer supply member that is disposed in the development chamber and supplies a developer to the developer carrier; and a regulating member that is in contact with the developer carrier and regulates a developer on a surface of the developer carrier, wherein stirring of the developer in the development chamber is performed by driving the first transport path and the second transport path to transport the developer.

By adopting the above-described configuration, it becomes possible to circulate a developer between the development chamber and the developer containing chamber and to stir the developer in the development chamber. As a result, since unevenness of the quality of the developer is prevented, deterioration of an output image can be prevented.

In addition, the first transport path may be driven on the basis of an amount of developer remaining in the development chamber. By adopting such a configuration, the amount of the developer in the development chamber can be maintained constant.

In addition, a driving speed of the first transport path may change according to a decrease degree of the developer in the development chamber. By adopting such a configuration, the developer can be properly supplied to the development chamber according to the decrease degree of the developer.

In addition, at least one of driving timing, driving time, and driving speed of the second transport path may change according to a deterioration index indicating generation of a deteriorated developer in the development chamber. By adopting such a configuration, circulation of the developer between the development chamber and the developer containing chamber can be properly performed according to generation of the deteriorated developer. In addition, when the driving timing is variable, the driving timing may be when the deterioration index exceeds a predetermined set value. By adopting such a configuration, collection of the developer can be performed at the proper driving timing through the second transport path.

In addition, when the driving time is variable, the driving time may be determined according to the deterioration index within a set time as a predetermined set value. By adopting such a configuration, collection of the developer can be performed for a proper time through the second transport path.

In addition, when the driving speed is variable, the driving speed may be determined according to a set coefficient as a predetermined set value. By adopting such a configuration, collection of the developer can be performed at the proper driving speed through the second transport path.

In addition, the predetermined set value may be set according to at least one environmental information, such as temperature or humidity. By adopting such a configuration, collection according to the environment becomes possible.

In addition, the deterioration index may be determined on the basis of print information. By adopting such a configuration, collection according to the printing state becomes possible.

In addition, the printed information may be print concentration information, such as a print duty and a printed dot, or a driving time of the developer carrier. By adopting such a configuration, collection suitable for the printing state becomes possible.

The deterioration index may be initialized when driving of the second transport path ends. By adopting such a configuration, preparation for next driving of the second transport path can be properly performed.

### BRIEF DESCRIPTION OF THE DRAWINGS

The invention will be described with reference to the accompanying drawings, wherein like numbers reference like elements.

FIG. 1 is a schematic view illustrating the configuration of an image forming apparatus to which a developing device according to an embodiment of the invention is applied.

FIG. 2 is a schematic view illustrating the cross section of the developing device according to the embodiment of the invention.

FIGS. 3A and 3B are external views illustrating a developing device to which or from which a separate toner containing portion (or a toner supply unit) is attached or detached.

FIGS. 4A and 4B are external views illustrating a developing device formed integrally with a toner containing portion.

FIG. 5 is a view illustrating the flow of supply processing.

FIGS. 6A to 6C are views illustrating various time charts of collection processing.

FIG. 7 is a view illustrating the flow of collection processing when the driving timing is variable.

FIG. 8 is a view illustrating the flow of collection processing when the driving time is variable.

FIG. 9 is a view illustrating the flow of collection processing when the driving speed is variable.

### DESCRIPTION OF EXEMPLARY EMBODIMENTS

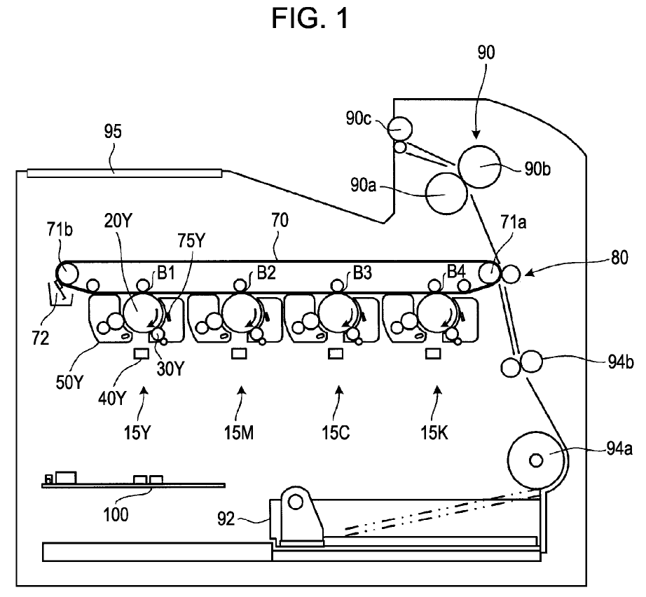

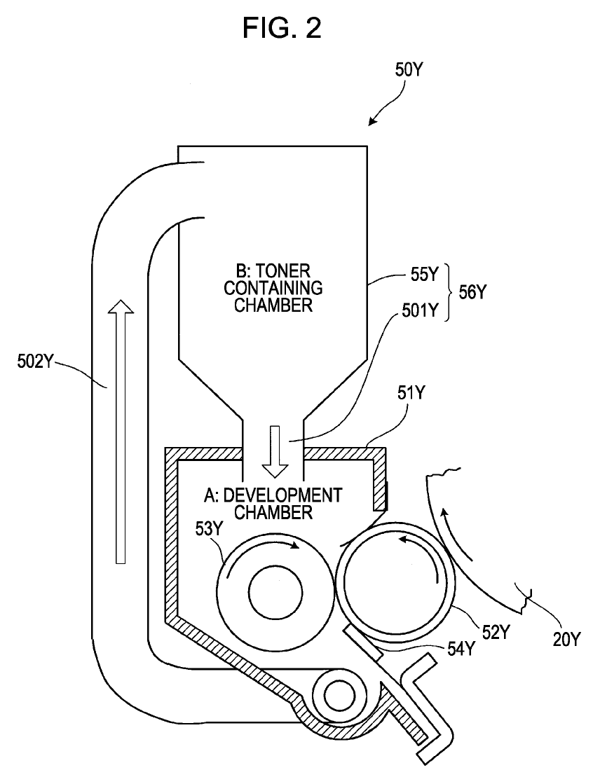

Hereinafter, embodiments of the invention will be described with reference to the accompanying drawings. In this embodiment, a tandem-type image forming apparatus in which a developing device is disposed in a horizontal direction is described as an example. However, the invention is not limited to the tandem-type image forming apparatus. For example, the invention may also be applied to image forming apparatuses disclosed in JP-A-11-102106 and JP-A-2007-178698 in which a developing device is disposed in a vertical direction. FIG. 1 is a view illustrating an image forming apparatus including a developing device according to an embodiment of the invention, and FIG. 2 is an enlarged view illustrating a developing unit 50 that develops a yellow color of FIG. 1.

As shown in FIG. 1, the image forming apparatus includes four image forming stations 15Y, 15M, 15C, and 15K, an intermediate transfer belt 70, a secondary transfer unit 80, a fixing unit 90, a display unit 95 that performs various kinds of notification to a user and is formed of a liquid crystal panel, and a control unit 100 that controls these units to thereby control an operation as an image forming apparatus.

Each of the image forming stations 15Y, 15M, 15C, and 15K has a function of forming an image with toner (‘developer’ in the invention) of each color of yellow (Y), magenta (M), cyan (C), and black (K). Hereinafter, since the configurations of the image forming stations 15Y, 15M, 15C, and 15K are the same, the image forming station 15Y will be representatively described in a condition where the alphabet of the end indicating each color is omitted.

The image forming station 15 has a charging unit 30, an exposure unit 40, a developing unit 50, a primary transfer portion B1, and a photoconductor cleaning unit 75 from the lower right side along the rotation direction of a photoconductor 20 as an example of an image carrier.

The photoconductor 20 has a cylindrical base and a photosensitive layer formed on an outer peripheral surface of the base and is able to rotate around a central shaft. In the present embodiment, the photoconductor 20 rotates clockwise as indicated by the arrow. The charging unit 30 is a device for electrically charging the photoconductor 20. The exposure unit 40 forms the electrostatic latent image on the electrically charged photoconductor 20 by irradiating a laser beam. The exposure unit 40 has a semiconductor laser, a polygon mirror, an F-θ lens, and the like. The exposure unit 40 irradiates onto the electrically charged photoconductor 20 a laser beam modulated on the basis of an image signal input from a host computer (not shown), such as a personal computer and a word processor. The developing unit 50 (‘developing device’ in the invention) is a device that develops the electrostatic latent image formed on the photoconductor 20 using the yellow (Y) toner to thereby form a toner image on the photoconductor 20. Details of the developing unit 50 will be described later.

Each of primary transfer portions B1, B2, B3, and B4 transfers the toner image formed on each photoconductor 20 onto the intermediate transfer belt 70. In case where toner images of four colors sequentially overlap to be transferred by the four primary transfer portions B1, B2, B3, and B4, a full-color toner image is formed on the intermediate transfer belt 70. The intermediate transfer belt 70 is an endless belt stretched over a belt driving roller 71a and a driven roller 71b and is driven to rotate in a state of being in contact with each photoconductor 20. The secondary transfer unit 80 is a device for transferring a monochrome toner image or a full-color toner image formed on the intermediate transfer belt 70 onto a transfer material, such as paper, a film, and a cloth. The fixing unit 90 is configured to include a fixing roller 90a and a pressure roller 90b. The fixing unit 90 is a device for fixing the monochrome toner image or the full-color toner image transferred onto the transfer material by fusion to thereby make a permanent image. The photoconductor cleaning unit 75 has a photoconductor cleaning member, such as a roller or a blade, which is formed of rubber and is in contact with a surface of the photoconductor 20. The photoconductor cleaning unit 75 is a device for removing the toner, which remains on the photoconductor 20 after the toner image is transferred onto the intermediate transfer belt 70 by the primary transfer portion B1, by scraping using the photoconductor cleaning member.

Next, an operation of the image forming apparatus configured as described above will be described. First, when an image signal and a control signal from a host computer (not shown) are input to the control unit 100 of the image forming apparatus through an interface, the photoconductor 20, a developing roller (an example of ‘developer carrier’ in the invention) and a supply roller provided in the developing unit 50, the intermediate transfer belt 70, and the like rotate by control of the control unit 100. The photoconductor 20 is sequentially charged at the charging position by the charging unit 30 while the photoconductor 20 is rotating.

An electrically charged region of the photoconductor 20 reaches the exposure position with rotation of the photoconductor 20, and an electrostatic latent image corresponding to image information of each color is formed in the region by the exposure unit 30. The electrostatic latent image formed on the photoconductor 20 reaches the developing position with rotation of the photoconductor 20 and is developed by the developing unit 50. As a result, a toner image is formed on the photoconductor 20. The toner image formed on the photoconductor 20 reaches the position of the primary transfer portion B1 with rotation of the photoconductor 20. Then, a primary transfer voltage with an opposite polarity to the charging polarity of toner is applied. Accordingly, the toner image is primary-transferred onto the intermediate transfer belt 70. As a result, the toner images of four colors formed on the photoconductors 20(Y, M, C, and K) are transferred onto the intermediate transfer belt 70 so as to overlap each other, and a full-color toner image is formed on the intermediate transfer belt 70.

The intermediate transfer belt 70 is driven when a driving force from a belt driving unit, such as a motor, is transmitted through the belt driving roller 71a. The full-color toner image formed on the intermediate transfer belt 70 is transferred onto a transfer material, such as paper, by the secondary transfer unit 80. The transfer material is transported from a paper feed tray 92 to the secondary transfer unit 80 through a paper feed roller 94a and a resist roller 94b. The full-color toner image transferred onto the transfer material is heated and pressed by the fixing unit 90 to be fused on the transfer material. After passing the fixing unit 90, the transfer material is discharged by a paper discharge roller 90c.

On the other hand, the photoconductor 20 is discharged by a discharge unit (not shown) after passing the position of the primary transfer portion B1. Then, the toner adhered on the surface of the photoconductor 20 is scraped by the photoconductor cleaning unit 75 in order to prepare for electric charging for forming a next electrostatic latent image. The scraped toner is collected in a remaining toner collecting portion provided in the photoconductor cleaning unit 75. The intermediate transfer belt 70 after secondary transfer is cleaned by an intermediate transfer belt cleaning unit 72 disposed at a side of the driven roller 71b.

Next, the developing unit 50 (‘developing device’ in the invention) will be described with reference to FIG. 2. In addition, similar to description of FIG. 1, an explanation will be made in a condition where the suffix of the alphabet indicating each color is omitted since the configurations of the developing units 50Y, 50M, 50C, and 50K of the colors are the same. The developing unit 50 includes a housing 51, a developing roller 52 (an example of a ‘developer carrier’ in the invention), a supply roller 53 (an example of a ‘developer supply member’ in the invention) a regulating member 54, a toner containing portion 55, a first transport path 501, and a second transport path 502. Moreover, it is assumed that one obtained by unification of the toner containing portion 55 and the first transport path 501 is called a supply unit 56.

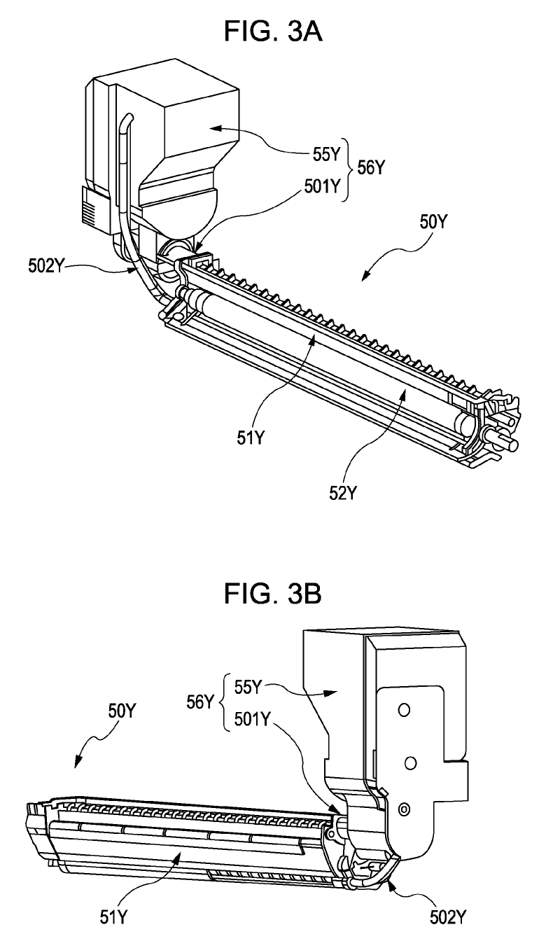

FIGS. 3A and 3B are external views illustrating the developing unit 50. In particular, FIGS. 3A and 3B are external views illustrating the developing unit 50 when the toner containing portion 55 or the supply unit 56 can be made to be attached or detached. FIG. 3A is the external view seen from one side, and FIG. 3B is the external view seen from the opposite direction. The toner containing portion 55 or the supply unit 56, in which the toner containing portion 55 and the first transport path 501 are united, seen on the left side of FIG. 3A is of a detachable cartridge type. Toner can be replaced by allowing those described above to be attached or detached.

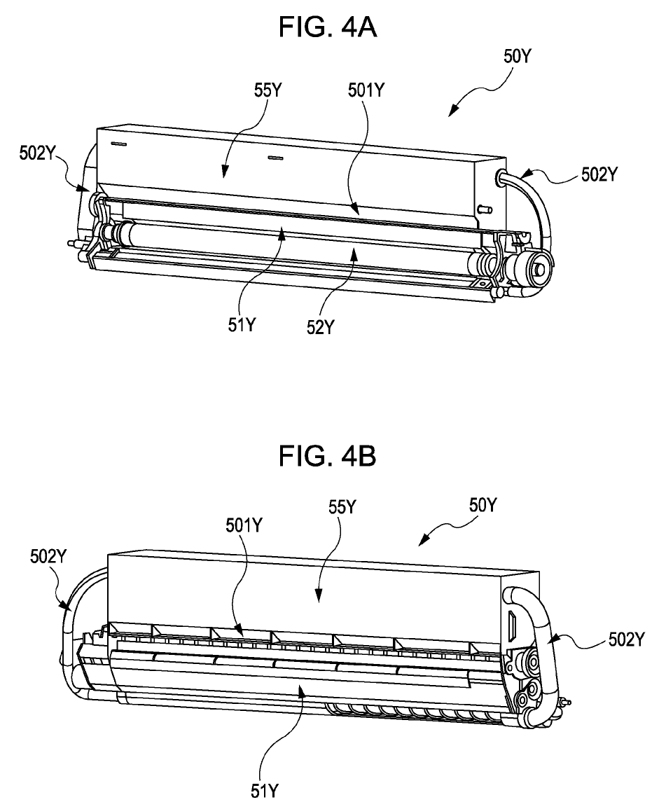

On the other hand, FIGS. 4A and 4B are external views illustrating the developing unit 50 having the toner containing portion 55 formed integrally therewith. Similar to FIGS. 3A and 3B, FIG. 4A is the external view seen from one side, and FIG. 4B is the external view seen from the opposite direction. In this configuration, the toner containing portion 55 cannot be attached or detached. Accordingly, the entire developing unit 50 is replaced at the time of toner replacement.

Referring back to FIG. 2, details of the developing unit 50 will be described. The housing 51 forms a development chamber A therein and houses the developing roller 52, the supply roller 53, and the regulating member 54 therein. The development chamber A is a chamber that contains the toner supplied from an upper portion through the first transport path 501. Moreover, a sensor (not shown) that detects the amount of contained toner is disposed in the development chamber A.

The developing roller 52 carries toner thereon and visualizes (develops) the electrostatic latent image, which is carried on the photoconductor 20 by the toner, as a toner image. A metallic roller, a rubber roller, and a resin roller may be used as the developing roller 52. In the case of the metallic roller, the developing roller 52 is manufactured by using aluminum, stainless steel, or iron, for example. In addition, the developing roller 52 is supported on the housing 51 and rotates around the central shaft in a direction (counterclockwise direction in FIG. 2) opposite to the rotation direction (clockwise rotation in FIG. 2) of the photoconductor 20.

The supply roller 53 is provided in the development chamber A and supplies the toner contained in the development chamber A to the developing roller 52. The supply roller 53 is formed of polyurethane foam, for example, and is in contact with the developing roller 52 in a state of being elastically deformed. The supply roller 53 is supported on the housing 51 and rotates around the central shaft in the direction (clockwise direction in FIG. 2) opposite to the rotation direction of the developing roller 52.

The regulating member 54 is in contact with the developing roller 52 in order to apply electric charges to the toner carried on the developing roller 52 and to regulate the thickness of the carried toner. A roller type member other than the blade type member shown in the drawing may also be used as the regulating member 54. Silicon rubber, polyurethane rubber, and the like are used as a blade portion of the blade type member shown.

In the toner containing portion 55, a toner containing chamber B that contains the toner therein is formed. The first transport path 501 used to transport the toner to the development chamber A and the second transport path 502 used to collect the toner from the development chamber A are connected to the toner containing portion 55.

Although the first transport path 501 is a member that transports toner from the toner containing chamber B to an upper side of the development chamber A. Although not shown, the first transport path 501 includes a driving unit that transports the toner, such as a screw conveyor or airflow, therein. It becomes possible to make the quality of toner in the development chamber A uniform by circulating the toner by controlling driving of the driving unit in a driving method, which will be described later.

The second transport path 502 is a member that transports the toner from an opening of the second transport path 502, which is located at an approximately lower side of the development chamber A, to the toner containing chamber B. Similar to the first transport path 501, the second transport path 502 includes a driving unit that transports the toner therein. It becomes possible to make the quality of toner in the development chamber A uniform by circulating the toner by controlling driving of the driving unit in various driving methods according to a deterioration degree of toner, which will be described later.

Here, the position of the opening of the second transport path 502 located in the development chamber A may be suitably determined in consideration of the relationship with the distribution of deteriorated toner generated in the development chamber A. As shown in FIG. 2, in the case of lower regulation in which the regulating member 54 is in contact with a lower side of the developing roller 52, the opening of the second transport path 502 located in the development chamber A is preferably positioned at an approximately lower portion of the development chamber A in order to efficiently collect the deteriorated toner near the lower portion of the development chamber A which is generated due to the mechanical stress between the developing roller 52 and the supply roller 53 or the mechanical stress between the developing roller 52 and the regulating member 54. Collection of the deteriorated toner can be performed more efficiently if the opening of the second transport path 502 located in the development chamber A is positioned approximately below the regulating member 54. However, this is an example when the lower regulation is adopted, and the position of the opening of the second transport path 502 may be determined according to the distribution of the deteriorated toner in the development chamber A. For example, in the case of upper regulation in which the regulating member 54 is in contact with an upper portion of the developing roller 52, the position may be suitably determined in consideration of the relationship with the distribution of the deteriorated toner.

In the developing unit 50 configured as described above, the following operation is executed when developing an electrostatic latent image on the photoconductor 20. That is, the supply roller 53 supplies the toner contained in the development chamber A to the developing roller 52. The thickness of the toner supplied to the developing roller 52 is regulated and electric charges are applied to the toner by the regulating member 54 as the developing roller 52 rotates. The toner on the developing roller 52 the thickness of which has been regulated reaches the developing position facing the photoconductor 20 as the developing roller 52 further rotates, thereby being supplied for development of the electrostatic latent image formed on the photoconductor 20 under the alternating electric field of the developing position. The toner on the developing roller 52 that was not supplied for the development returns to the development chamber A as the developing roller 52 further rotates.

Next, circulation of the toner, which is a feature of the invention, will be described. The toner forms a circulating path in which the toner is supplied from the toner containing chamber B into the development chamber A through the first transport path 501 and then returns from the development chamber A into the toner containing chamber B through the second transport path 502. In the development chamber A, the toner consumed in the development of an electrostatic latent image on the photoconductor 20 by printing is generated. Accordingly, the amount of toner in the entire circulating path decreases by the consumed toner.

Here, the first transport path 501 and the second transport path 502 may be driven independently from each other. By driving the path of supply using the first transport path 501 and the path of collection using the second transport path 502 independently, it is possible to flexibly deal with the amount of consumed toner or the amount and quality of deteriorated toner changing according to the situation of printing. As a result, the amount and quality of toner in the development chamber A can be suitably maintained.

At the start of use of the image forming apparatus or at the start of use of the developing unit 50 including replacement of the developing unit 50, replacement of the toner containing portion 55, and replacement of the supply unit 56, three states of a state where there is new toner in the development chamber A, a state where there is no toner in the development chamber A, and a state where there is deteriorated toner in the development chamber A are considered as states of toner in the development chamber A. Hereinafter, operations until a printable state is set from the start of use in these states will be described. In addition, these operations do not need to be necessarily performed before printing and may also be realized by toner circulation based on the normal printing operation.

First, in the state where there is new toner in the development chamber A, a state where printing can be started is set if there is a predetermined amount of new toner in the development chamber A. When there is no predetermined amount of new toner in the development chamber A, the state where printing can be started is set by driving the first transport path 501 so that toner is supplied from the toner containing chamber B to the development chamber A until the amount of toner reaches the predetermined amount.

Next, in the state where there is no toner in the development chamber A, the state where printing can be started is set by driving the first transport path 501 so that new toner is supplied from the toner containing chamber B to the development chamber A until the amount of toner in the development chamber A reaches the predetermined amount. In these two states, since the toner in the circulating path is only new toner, unevenness of the quality in the development chamber A does not exist.

Finally, a case where the amount of deteriorated toner in the development chamber A becomes less than the predetermined amount in the state where the deteriorated toner remains in the development chamber A will be described. In this case, since the amount of toner in the development chamber A is less than the predetermined amount, it is necessary to newly supply new toner in a quantitative point. From the point of view of removal of unevenness of the quality of toner in the invention, it is not preferable that there is a difference between the quality of toner in the development chamber A and the quality of toner in the toner containing chamber B, which is sufficient to cause deterioration of an output image. This is because when new toner is newly supplied from the toner containing chamber B with consumption or collection of deteriorated toner in the development chamber A, unevenness between the deteriorated toner and the new toner occurs in the development chamber A. Therefore, it is preferable to set a state where printing can be started after circulating toner by driving the second transport path 502 and the first transport path 501 for a predetermined time before toner in the toner containing chamber B reaches being observed as deterioration of an output image and stirring deteriorated toner and new toner by performing rotation driving of the supply roller 53 and the developing roller 52 in the development chamber A so that the quality of the deteriorated toner in the development chamber A and the quality of the deteriorated toner in the toner containing chamber B become uniform. In addition, it is more preferable that stirring of toner in the development chamber A be performed by rotating only the supply roller 53 and stopping rotation driving of the developing roller 52 since the toner is not scattered from the opening of the developing unit 50.

Next, supply processing using the first transport path 501, which is responsible for circulation of toner, and collection processing using the second transport path 502 will be described. The control unit 100 includes: a storage portion that stores environmental information having an effect on deterioration of toner, such as temperature or humidity, a value set on the basis of environmental information, and print information used as an index of generation of deteriorated toner changing according to the situation of printing, such as print concentration information or driving time of a developing roller; a deterioration index calculating portion that calculates a deterioration index indicating generation of deteriorated toner generated in the development chamber A, which will be described later; a determination portion that determines circulation of toner and control of stirring from various kinds of information stored in the storage portion and a calculation result of the deterioration index calculating portion; and a driving control portion that drives the first transport path 501, the second transport path 502, the supply roller 53, and the developing roller 52 by a control signal from the determination portion.

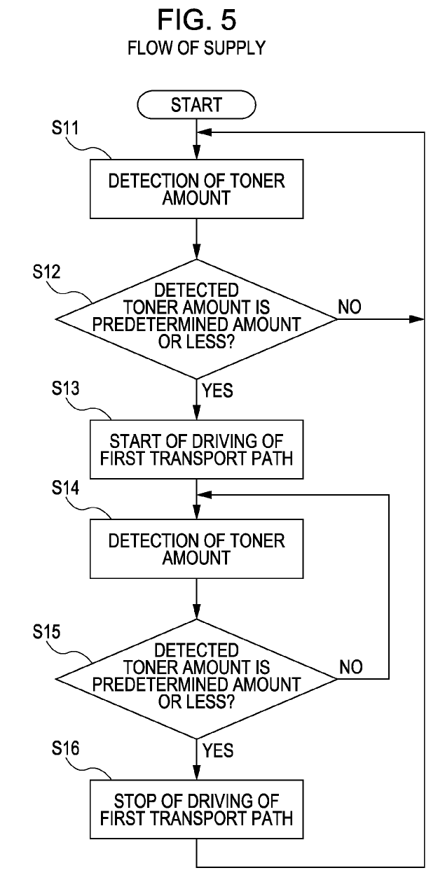

FIG. 5 is a flow chart illustrating an example of toner supply processing based on driving of the first transport path 501. The supply of toner is performed on the basis of the amount of toner in the development chamber A, and it is considered to use a piezoelectric element or a light-transmissive photosensor for detection of the toner amount. In addition, any type of sensor may be used as long as the sensor can detect the amount of toner in the development chamber A, without being limited to those described above.

First, in step S11, the amount of toner in the development chamber A is detected using various sensors described above. Then, it is determined whether or not the detected toner amount is a predetermined amount or less is made (step S12). When there is the predetermined amount of toner in the development chamber A, the process returns to step S11 to repeat detection of the amount of toner in the development chamber A using a sensor. On the other hand, when the toner in the development chamber A is reduced due to consumption of toner by printing or collection of toner using the second transport path 502, it is determined that the amount of toner is the predetermined amount or less in step S12 and the supply of toner using the first transport path 501 in step S13 and subsequent steps is started.

In step S13, the first transport path 501 is driven to start the supply of toner from the toner containing chamber B to the development chamber A. In step 14, although the amount of toner in the development chamber A is detected as described above, a determination on whether or not the amount of toner has reached the predetermined amount is made herein (step S15). When the amount of toner has not reached the predetermined amount, the toner is continuously supplied. When the amount of toner has reached the predetermined amount, driving of the first transport path 501 is stopped to stop the supply of toner into the development chamber A (step S16).

In addition, although not shown in FIG. 5, it may be possible to adopt a configuration in which the driving speed of the first transport path 501 changes according to the degree of reduction in the toner in the development chamber A in order to immediately respond to lack of the amount of toner in the development chamber A. For example, when the amount of toner in the development chamber A has been reduced rapidly, supply according to the degree of reduction in toner in the development chamber A becomes possible by driving the first transport path 501 at a higher speed than the normal speed. By the above-described supply processing using the first transport path 501, a fixed amount of toner can be secured in the development chamber A.

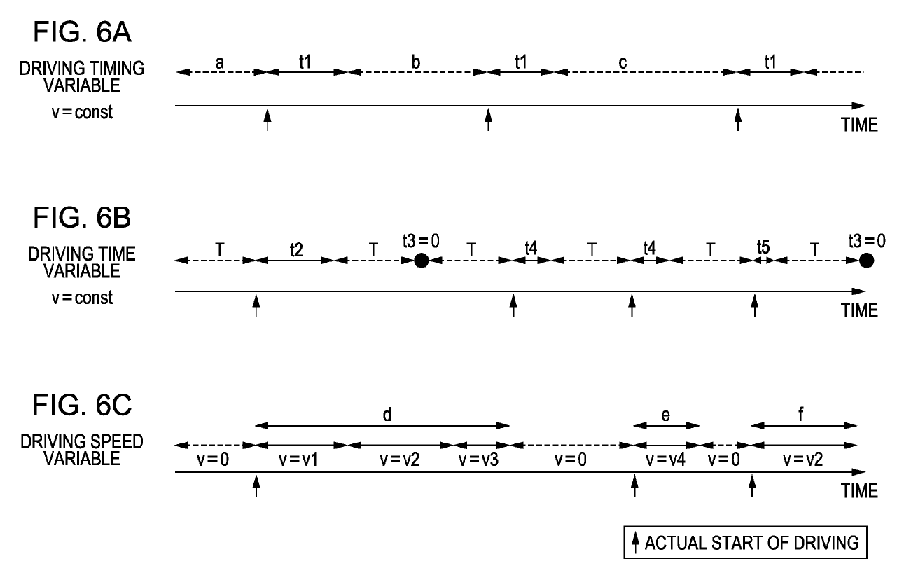

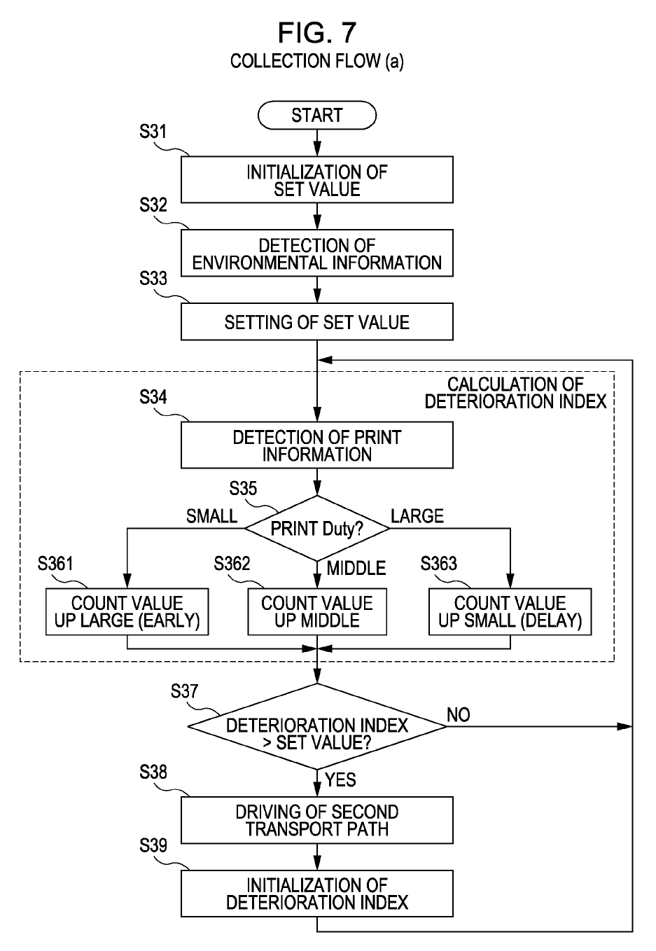

Next, toner collection processing based on driving of the second transport path 502 will be described with reference to FIGS. 6A to 9. FIGS. 6A to 6C are views illustrating various time charts of toner collection processing. FIGS. 7 to 9 are views illustrating flows of various kinds of toner collection processing.

Collection of toner through the second transport path 502 from the development chamber A is basically performed according to the deterioration index indicating generation of deteriorated toner generated in the development chamber A, which will be described later. Various collection methods according to the amount of generated deteriorated toner may be considered for driving of the second transport path 502. Here, an explanation will be made through the divided cases of (a) case where the driving timing of the second transport path 502 is variable (b) case where the driving time of the second transport path 502 is variable, and (c) case where the driving speed of the second transport path 502 is variable as shown in the time charts of FIGS. 6A to 6C. The division into the three cases of (a), (b), and (c) is performed for the sake of easy explanation. In practice, the three kinds of driving may be appropriately combined.

First, the case where the driving timing is variable will be described using the time chart shown in FIG. 6A and the flow shown in FIG. 7. When the new developing unit 50 including the development chamber A is mounted in the image forming apparatus, initialization of a set value is first performed (step S31). This set value is a value used as a threshold value of a deterioration index to be described later. Then, in step S32, environmental information is detected by various sensors provided in the image forming apparatus (preferably provided near the developing unit 50). Although various kinds of information having an effect on deterioration of toner, such as temperature or humidity, are adopted as the environmental information, both the temperature and the humidity may be adopted for precise control or one of the temperature and the humidity may be simply adopted. Moreover, the environmental information is not limited to those described above as long as corresponding information has an effect on deterioration of toner.

In step S33, a predetermined set value is set on the basis of the detected environmental information. For example, a small set value is set in a situation where the degree of deterioration of toner is large like high temperature and high humidity, and a large set value is set in a situation where the degree of deterioration of toner is small. In addition, the setting based on the environmental information may be omitted in any collection flow. In this case, it becomes possible to make processing simple even though precise control based on environmental information cannot be made.

In steps S34 to S363, a deterioration index is calculated. This deterioration index is a value used as an index of a deteriorated developer in the development chamber A and may be calculated on the basis of various kinds of print information. For example, in the flow example shown in FIG. 7, the deterioration index may be calculated by using a print duty that is one of information indicating the concentration of printing. In addition to that described above, information as the index of the deteriorated developer generation changing in a printing situation, such as a printed dot or the driving time of the developing roller, may be used. In addition, a plurality of information items may also be used in a state of being suitably combined.

In step S34, the print duty is detected as print information under the situation where printing is being performed. Step S35 branches to three cases of steps S361 to S363 according to the detected print duty. The second transport path 502 may be controlled more precisely by performing branching to a more number of cases.

When the print duty detected in step S35 is small, that is, when the amount of consumed toner that moves from the developing roller 52 to the photoconductor 20 is small since the printing concentration is low, the amount of toner that returns from the developing roller 52 to the development chamber A increases eventually. There is a large possibility that the toner will become deteriorated toner in the development chamber A. As a result, when the print duty is small, the amount of deteriorated toner increases. In this case, the process proceeds to step S361 in which a time taken to reach the set value is shortened by making the width of a count value large or counting the count value quickly, such that the driving timing becomes early. Since it can be said that the count value is a value related to generation of deteriorated toner, the count value is called a deterioration index in the invention.

Then, when the print duty detected in step S35 is large, that is, when the amount of consumed toner that moves from the developing roller 52 to the photoconductor 20 is large since the printing concentration is high, the amount of toner that returns from the developing roller 52 to the development chamber A decreases. Accordingly, when the print duty is large, it is assumed that the amount of deteriorated toner decreases. In this case, the process proceeds to step S363 in which the time taken to reach the set value is increased by making the width of a count value small or counting the count value slowly, such that the driving timing becomes delayed.

When the print duty detected in step S34 is the middle of both the print duties in the above cases, the process proceeds to step S362 in which the deterioration index is counted by setting the width of the count value or the count speed to the middle of those described above.

In step S37, it is determined whether or not the counted deterioration index exceeds the set value set in step S33. When the deterioration index does not exceed the set value, the process returns to step 34 again to continuously count the deterioration index. On the other hand, when the deterioration index exceeds the set value, it is determined that the deteriorated toner is collected and the second transport path 502 is driven for a predetermined time to collect the deteriorated toner (step S38). After driving of the second transport path 502 ends, the deterioration index is initialized in step S39 and the process returns to step S34 again to start counting of the deterioration index.

In addition, although the process returns to step S34 to count the deterioration index after collection of deteriorated toner in the flow shown in FIG. 7, the process returns to first step S31 to detect environmental information again and reset the set value. Thus, a precise control according to the environmental change becomes possible by resetting the set value.

An example where an operation in the case where the driving timing of the second transport path 502 is variable is shown in a time-sequential manner is shown in FIG. 6A. In FIG. 6A, a period t1 shown by a solid line is a driving period of the second transport path 502, and the driving period and the transport speed are equal. Moreover, driving of the second transport path 502 is started at the head (timing shown by upward arrow) of each period t1. On the other hand, sections a, b, and c shown by dotted lines indicate idle periods of the second transport path 502, and the time length of each of the periods changes according to the environmental information or the deterioration index. Assuming that the environmental information is uniform on the time axis shown in the drawing, it can be read that the shortest section a is a section in which a relatively large amount of deteriorated toner is generated and the longest section c is a section in which a relatively small amount of deteriorated toner is generated.

As described above, collection according to generation of deteriorated toner in the development chamber A becomes possible by changing the driving timing of the second transport path 502 according to the environmental information and the deterioration index. As a result, smooth circulation and stirring of toner, that is, the amount of toner and the uniform quality of toner in the development chamber A can be secured by combination of supply of the first transport path 501 and at least rotation driving of the supply roller 53.

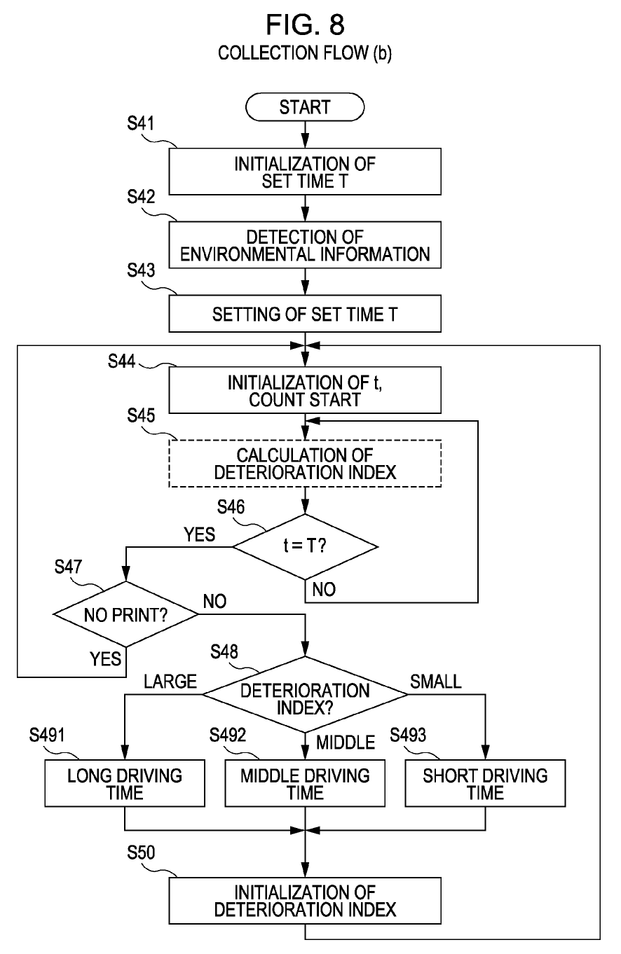

Next, the case where the driving time of the second transport path 502 is variable will be described using the time chart shown in FIG. 6B and the flow shown in FIG. 8.

In the case of driving the second transport path 502 by changing the driving time of the second transport path 502, when the new developing unit 50 including the development chamber A is mounted in the image forming apparatus, initialization of a set value T is first performed (step S41). The set time T is a time to become a monitoring period of a deterioration index, which will be described later. In step S42, environmental information is detected by various sensors provided in the image forming apparatus (preferably provided near the developing unit 50). Although various kinds of information having an effect on deterioration of toner, such as temperature or humidity, are adopted as the environmental information, both the temperature and the humidity may be adopted for precise control or one of the temperature and the humidity may be simply adopted. Moreover, the environmental information is not limited to those described above as long as corresponding information has an effect on deterioration of toner. Then, the set time T as a predetermined set value corresponding to the environmental information is set (step S43). The set time T becomes a period for which the deterioration index is monitored, which will be described later. For example, in the environment where deterioration of toner is large, such as high temperature and high humidity, the monitoring period is shortened by making the set time T short.

In step S44, a time t is initialized to start counting. Until the time t to count reaches the set time T (step S46) the deterioration index is calculated by detecting print information (step S45). Calculation of the deterioration index surrounded by a broken line is performed almost similar to calculation of the deterioration index surrounded by a broken line of FIG. 7. When the time t has reached the set time T, that is, when it is determined that the monitoring period has ended (step S46), it is determined whether or not printing was performed during the set time T in step S47. When it is determined that the printing was performed, the process proceeds to step S48. Then, driving of the second transport path 502 is performed in steps S491 to S493 according to the deterioration index calculated in step S45.

When the deterioration index within the period of the set time T is large, it is determined that the amount of generated deteriorated toner is large and then the second transport path 502 is driven for a long time (step S491). Then, when the deterioration index within the period of the set time T is small, it is determined that the amount of deteriorated toner is small and then the second transport path 502 is driven for a short time (step S493). In addition, when the print duty is the middle of both the print duties in the above cases, the second transport path 502 is driven for a time between the times in the above cases (step S492). Then, after driving of the second transport path 502 ends, the deterioration index is initialized in step S50 and the process returns to step S44 in which the deterioration index is calculated.

On the other hand, when it is determined that printing was not performed in step S47, the process returns to step S44 to calculate a deterioration index without driving the second transport path 502. Moreover, also when the driving time is variable, the process returns to step S41 to detect the environmental information again and reset the set value T similar to the case where the driving timing is variable.

An example where an operation in the case where the driving time of the second transport path 502 is variable is shown in a time-sequential manner is shown in FIG. 6B. In FIG. 6B, a period shown by a broken line indicates a set time T, that is, a period for which a deterioration index is monitored. When there is no printing during the period of the set time T, the period of the set time T is set again without driving the second transport path 502 as shown by t3=0. On the other hand, when the deterioration index is large during the period of the set time T, it is determined as a period for which a large amount of deteriorated toner was generated and the second transport path 502 is driven during a relatively long period t2. Moreover, when the deterioration index is relatively small, it is determined as a period for which a small amount of deteriorated toner was generated and the second transport path 502 is driven during a relatively short period t5.

As described above, collection according to generation of deteriorated toner in the development chamber A becomes possible by changing the driving time of the second transport path 502 according to the environmental information and the deterioration index. As a result, smooth circulation and stirring of toner, that is, the amount of toner and the uniform quality of toner in the development chamber A can be secured by combination of supply of the first transport path 501 and at least rotation driving of the supply roller 53.

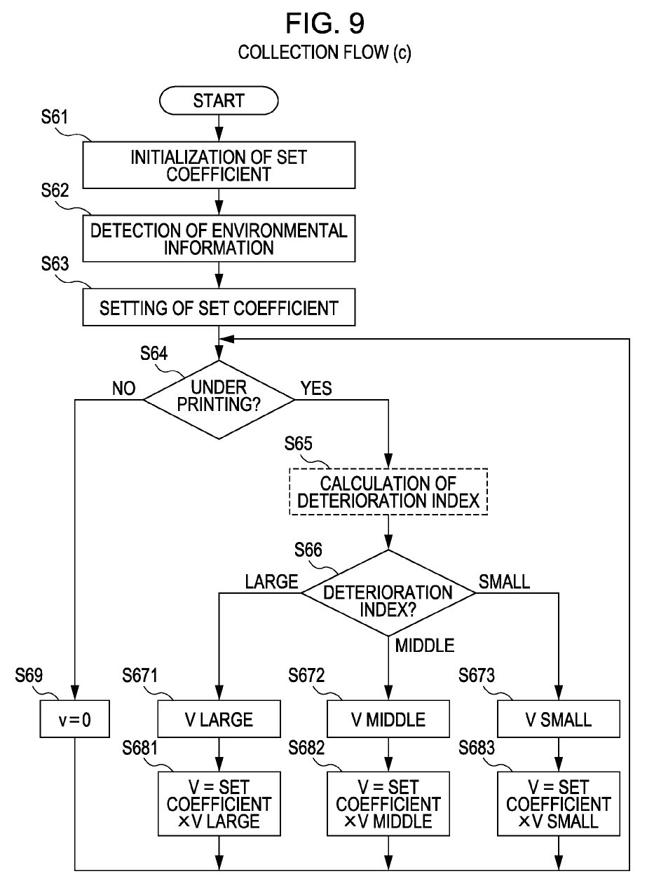

Finally, the case where the driving speed of the second transport path 502 is variable will be described using the time chart shown in FIG. 6C and the flow shown in FIG. 9.

In the case of driving the second transport path 502 by changing the driving speed of the second transport path 502, when the new developing unit 50 including the development chamber A is mounted in the image forming apparatus, initialization of a set coefficient is first performed (step S61). The set coefficient serves as a coefficient for adjusting the driving speed of the second transport path 502 to be described later. In step S62, environmental information is detected by various sensors provided in the image forming apparatus (preferably provided near the developing unit 50). Although various kinds of information having an effect on deterioration of toner, such as temperature or humidity, are adopted as the environmental information, both the temperature and the humidity may be adopted for precise control or one of the temperature and the humidity may be simply adopted. Moreover, the environmental information is not limited to those described above as long as corresponding information has an effect on deterioration of toner. Then, the set coefficient as a predetermined set value corresponding to the environmental information is set (step S63). The set coefficient becomes a coefficient for adjusting the driving speed of the second transport path 502, which will be described later. For example, in the environment where deterioration of toner is large, such as high temperature and high humidity, the driving speed of the second transport path 502 is increased by making the set coefficient large.

In step S64, it is determined whether or not printing is being performed. When printing is not being performed, the process proceeds to step S69 in which the driving speed of the second transport path 502 is set to zero, that is, driving of the second transport path 502 is not performed, returning to step S64. On the other hand, when it is determined that printing is being performed in step S64, the process proceeds to step S65 in which the deterioration index is calculated by detecting print information. Calculation of the deterioration index in step S65, which is surrounded by a broken line, is performed similar to calculation of the deterioration index surrounded by the broken line of FIG. 7. Then, step S66 branches to steps S671 to S673 according to the calculated deterioration index. When the deterioration index is large, a relatively large speed V (large) is set (S671). Then, driving of the second transport path 502 is performed by determining the driving speed of the second transport path 502 by multiplying the speed V (large) by the set coefficient set in step S63 (S681). When the deterioration index is small, a relatively small speed V (small) is set (S673). Then, driving of the second transport path 502 is performed by determining the driving speed by multiplying the speed V (small) by the set coefficient set in step S63 (S683). In addition, when the deterioration index is the middle of both the deterioration indices in the above cases, a speed V (middle) is set (S672). Then, driving of the second transport path 502 is performed by determining the driving speed by multiplying the speed by the set coefficient (S682). By performing steps 64 to S69, the second transport path 502 can be driven according to the deterioration index.

In addition, when the driving speed is variable, a precise control according to the environmental change becomes possible by resetting the set coefficient based on the environmental information in steps S61 to S63 at proper timing.

An example where an operation in the case where the driving speed of the second transport path 502 is variable is shown in a time-sequential manner is shown in FIG. 6C. In FIG. 6C, a period shown by a broken line is a period for which the second transport path 502 is not driven because printing is not performed (v=0). On the other hand, sections d, e, and f indicate periods for which driving of the second transport path 502 according to the deterioration index is performed. Particularly in the section d, it is shown that the driving speed of the second transport path 502 changes to v1, v2, and v3 according to the deterioration index changing under the printing situation.

As described above, collection according to generation of deteriorated toner in the development chamber A becomes possible by changing the driving speed of the second transport path 502 according to the environmental information and the deterioration index. As a result, smooth circulation and stirring of toner, that is, the amount of toner and the uniform quality of toner in the development chamber A can be secured by combination of supply of the first transport path 501 and at least rotation driving of the supply roller 53.

Furthermore, although the driving speed of the second transport path 502 is determined by multiplying the speed set according to the deterioration index by the set coefficient in this example, the set coefficient may be fixed to 1, for example. In this case, it becomes possible to make processing simple even though precise control based on the set coefficient cannot be made. Furthermore, although the speed of the second transport path 502 is set to follow the change in deterioration index, the driving speed of the second transport path 502 may be determined by monitoring the deterioration index within the set time, for example, like the case where the driving time is variable. In this case, after driving of the second transport path 502 ends, the deterioration index is initialized in step S50 and the process returns to step S64 in which a determination on whether or not printing is being performed is made.

Until now, the driving timing, the driving time, and the driving speed of the second transport path 502 have been described. However, these are only for making the explanation easy, and driving of the second transport path 502 may also be performed by appropriate combination of the driving timing, the driving time, and the driving speed.

As described above, in the invention, it becomes possible to supply toner with uniform quality for development by adopting the configuration where toner is circulated between the development chamber A and the toner containing chamber B. As a result, deterioration of the output image, such as regulation passing failure or fogging and a decrease in concentration or development record can be prevented.

The entire disclosure of Japanese Patent Application No. 2008-089050, filed Mar. 31, 2008 is expressly incorporated by reference herein.

What is claimed is:

1. A developing device comprising:
a housing that forms a development chamber therein;
a developer containing portion that forms a developer containing chamber therein and contains a one-component developer;
a first transport path used to supply a developer from the developer containing chamber to an upper side of the development chamber;
a second transport path used to collect a developer from a lower side of the development chamber to the developer containing chamber;
a developer carrier that is disposed in the development chamber and carries a developer thereon;
a developer supply member that is disposed in the development chamber and supplies a developer to the developer carrier; and
a regulating member that is in contact with the developer carrier and regulates a developer on a surface of the developer carrier,
wherein stirring of the developer in the development chamber is performed by driving the first transport path and the second transport path to transport the developer.

2. The developing device according to claim 1,
wherein the first transport path is driven on the basis of an amount of developer remaining in the development chamber.

3. The developing device according to claim 2,
wherein a driving speed of the first transport path changes according to a decrease degree of the developer in the development chamber.

4. The developing device according to claim 1,
wherein at least one of driving timing, driving time, and driving speed of the second transport path changes according to a deterioration index indicating generation of a deteriorated developer in the development chamber.

5. The developing device according to claim 4,
wherein when the driving timing is variable, the driving timing is when the deterioration index exceeds a predetermined set value.

6. The developing device according to claim 4,
wherein when the driving time is variable, the driving time is determined according to the deterioration index within a set time as a predetermined set value.

7. The developing device according to claim 4,
wherein when the driving speed is variable, the driving speed is determined according to a set coefficient as a predetermined set value.

8. The developing device according to claim 5,
wherein the predetermined set value is set according to at least one environmental information, such as temperature or humidity.

9. The developing device according to claim 4,
wherein the deterioration index is determined on the basis of print information.

10. The developing device according to claim 9,
wherein the printed information is print concentration information, such as a print duty and a printed dot, or a driving time of the developer carrier.

11. The developing device according to claim 4,
wherein the deterioration index is initialized when driving of the second transport path ends.

12. An image forming apparatus comprising the developing device according to claim 1.
